(19) United States
(12) Patent Application Publication
(10) Pub. No.: US 2007/0152588 A1
(43) Pub. Date: Jul. 5, 2007

(54) PLASMA DISPLAY PANEL

(75) Inventor: Oedong Kim, Seongnam-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/470,925

(22) Filed: Sep. 7, 2006

(30) Foreign Application Priority Data
Sep. 8, 2005 (KR) 10-2005-0083860

(51) Int. Cl. H01J 17/49

(52) U.S. Cl. 313/586; 313/582; 313/587; 313/583; 313/584

(57) ABSTRACT

A plasma display panel is disclosed. The plasma display panel includes a well-type barrier rib, a scan electrode, a sustain electrode and a black layer. The well-type barrier rib is formed between a front substrate and a rear substrate, comprises a transverse barrier rib and a longitudinal barrier rib for partitioning a plurality of discharge cells. The scan electrode and the sustain electrode are formed between the front substrate and the rear substrate in parallel to the transverse barrier rib. The black layer comprises a first black layer portion formed on the front substrate at a location corresponding to the transverse barrier rib, and a second black layer portion formed on the front substrate at a location corresponding to a portion of the longitudinal barrier rib.

This Nonprovisional application claims priority under 35 U.S.C. § 119(a) on Patent Application No. 10-2005-0083860 filed in Korea on Sep. 8, 2005 the entire contents of which are hereby incorporated by reference.

### BACKGROUND

1. Field

This document relates to a plasma display panel.

2. Description of the Related Art

A plasma display panel comprises a front panel, a rear panel and barrier ribs formed between the front panel and the rear panel. The barrier ribs forms unit discharge cell or discharge cells. Each of discharge cell is filled with an inert gas containing a main discharge gas such as neon (Ne), helium (He) and a mixture of Ne and He, and a small amount of xenon (Xe). The plurality of discharge cells form one pixel. For example, a red (R) discharge cell, a green (G) discharge cell and a blue (B) discharge cell form one pixel.

When a high frequency voltage is applied to the discharge cells to generate a discharge, the inert gas generates vacuum ultra-violet rays, which thereby cause phosphors formed between the barrier ribs to emit light, thus displaying an image.

The plasma display panel comprises a plurality of electrodes, for example, a scan electrode, a sustain electrode and a data electrode. Drivers for supplying a driving voltage to each of the electrodes of the plasma display panel are connected to each of the electrodes.

When driving the plasma display panel, each of the drivers supplies a reset pulse during a reset period, a scan pulse during an address period, and a sustain pulse during a sustain period to each of the electrodes of the plasma display panel, thereby displaying an image. Since the plasma display panel can be manufactured to be thin and light, it has attracted attention as a next generation display device.

A discharge characteristic of the plasma display panel may vary due to various factors such as the discharge cell and the electrodes of the plasma display panel. To optimize the discharge characteristic of the plasma display panel, the structure of the plasma display panel is being studied actively.

### SUMMARY

In one aspect, a plasma display panel comprises a front substrate and a rear substrate, a well-type barrier rib, formed between the front substrate and the rear substrate, comprising a transverse barrier rib and a longitudinal barrier rib for partitioning a plurality of discharge cells, a scan electrode and a sustain electrode formed between the front substrate and the rear substrate in parallel to the transverse barrier rib, and a black layer comprising a first black layer portion formed on the front substrate at a location corresponding to the transverse barrier rib, and a second black layer portion formed on the front substrate at a location corresponding to a portion of the longitudinal barrier rib.

In another aspect, a plasma display panel comprises a front substrate and a rear substrate, a well-type barrier rib, formed between the front substrate and the rear substrate, comprising a transverse barrier rib and a longitudinal barrier rib for partitioning a plurality of discharge cells, and a bus electrode formed on the front substrate or the rear substrate in parallel to the transverse barrier rib, wherein the shape of the bus electrode is not a straight-line.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 illustrates an example of a plasma display apparatus;

FIG. 2 illustrates the structure of a plasma display panel of the plasma display apparatus;

FIG. 3 illustrates an example of a method for achieving gray level of an image displayed on the plasma display panel;

FIG. 4 illustrates an example of a driving waveform of the plasma display panel;

FIG. 5 illustrates another structure of the plasma display panel;

FIG. 6 illustrates the structure of a black layer of the plasma display panel; and

FIG. 7 illustrates still another structure of a plasma display panel according to a third embodiment.

### DETAILED DESCRIPTION OF PREFERRED EMBODIMENTS

Preferred embodiments of the present invention will be described in a more detailed manner with reference to the drawings.

A plasma display panel comprises a front substrate and a rear substrate, a well-type barrier rib, formed between the front substrate and the rear substrate, comprising a transverse barrier rib and a longitudinal barrier rib for partitioning a plurality of discharge cells, a scan electrode and a sustain electrode formed between the front substrate and the rear substrate in parallel to the transverse barrier rib, and a black layer comprising a first black layer portion formed on the front substrate at a location corresponding to the transverse barrier rib, and a second black layer portion formed on the front substrate at a location corresponding to a portion of the longitudinal barrier rib.

The first black layer portion and the second black layer portion may be connected to each other at an intersection of the transverse barrier rib and the longitudinal barrier rib.

The second black layer portion may project from the first black layer portion at a location corresponding to the longitudinal barrier rib.

An area of the second black layer portion may range from 20% to 40% of a total area of the black layer.

The width of the longitudinal barrier rib may decrease until a predetermined distance as the longitudinal barrier rib extends away from the transverse barrier rib, and the width of the longitudinal barrier rib remains constant for a predetermined distance.

The shape of the second black layer portion projection may be in the form of a trapezoid.

The well-type barrier rib may partition the plurality of discharge cells such that each of the plurality of discharge cells may have a polygon shape having six or more sides.

The well-type barrier rib may partition the plurality of discharge cells such that each of the plurality of discharge cells may be oval shaped.

A plasma display panel comprises a front substrate and a rear substrate, a well-type barrier rib, formed between the front substrate and the rear substrate, comprising a transverse barrier rib and a longitudinal barrier rib for partitioning a plurality of discharge cells, and a bus electrode formed on the front substrate or the rear substrate in parallel to the transverse barrier rib, wherein the shape of the bus electrode is not a straight-line.

The bus electrode may comprise a projecting portion formed at a location corresponding to the longitudinal barrier rib.

The width of the projecting portion of the bus electrode may decrease as the projecting portion extends away from the transverse barrier rib.

The shape of the projecting portion of the bus electrode may be a trapezoid.

The plasma display panel may further comprise a black layer formed to be substantially the same shape as the bus electrode.

The black layer may comprise a projecting portion formed at a location corresponding to the longitudinal barrier rib.

The width of the projecting portion of the black layer may decrease as the projecting portion extends away from the transverse barrier rib.

The shape of the projecting portion of the black layer may be a trapezoid.

The well-type barrier rib may partition the plurality of discharge cells such that each of the plurality of discharge cells may have a polygon shape having six or more sides.

The well-type barrier rib may partition the plurality of discharge cells such that each of the plurality of discharge cells may be oval shaped.

Hereinafter, exemplary implementations will be described in detail with reference to the attached drawings.

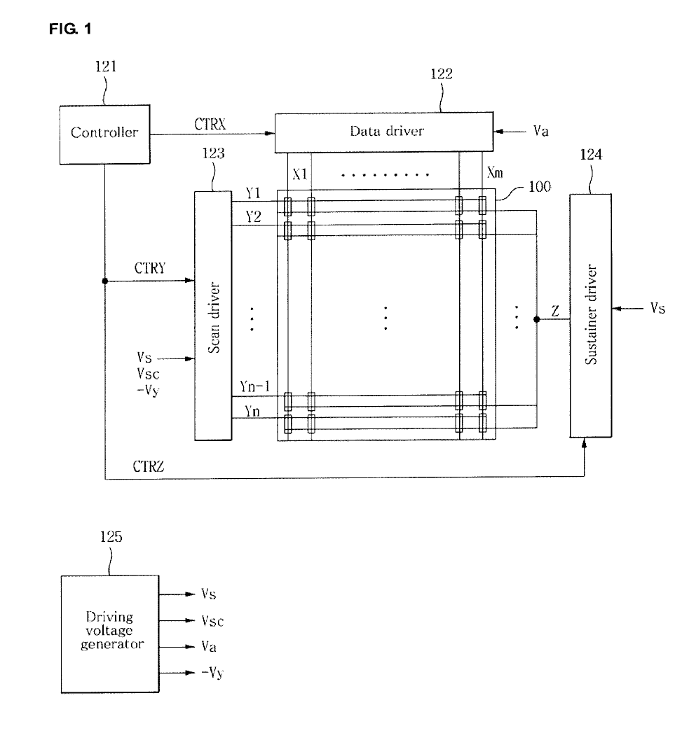

FIG. 1 illustrates an example of a plasma display apparatus.

As illustrated in FIG. 1, the plasma display apparatus comprises a plasma display panel 100 on which an image is displayed by processing image data input from the outside, a driver for supplying a driving pulse to electrodes of the plasma display panel 100, a controller 121 and a driving voltage generator 125. The driver includes a data driver 122 for supplying data to data electrodes X1 to Xm, a scan driver 123 for driving scan electrodes Y1 to Yn, and a sustain driver 124 for driving sustain electrodes Z being common electrodes. The controller 121 controls the data driver 122, the scan driver 123 and the sustain driver 124 when driving the plasma display panel 100. The driving voltage generator 125 supplies a necessary driving voltage to each of the drivers 122, 123 and 124.

The plasma display panel 100 comprises a front substrate (not illustrated) and a rear substrate (not illustrated) which are coalesced with each other at a given distance. On the front substrate, a plurality of electrodes, for example, the scan electrodes Y1 to Yn and the sustain electrodes Z are formed in pairs. On the rear substrate, the data electrodes X1 to Xm are formed to intersect the scan electrodes Y1 to Yn and the sustain electrodes Z.

The data driver 122 receives data mapped for each subfield by a subfield mapping circuit (not illustrated) after being inverse-gamma corrected and error-diffused through an inverse gamma correction circuit (not illustrated) and an error diffusion circuit (not illustrated), or the like. The data driver 122, under the control of the controller 121, samples and latches the mapped data, and then supplies a data pulse in accordance with the data to the data electrodes X1 to Xm.

The scan driver 123, under the control of the controller 121, supplies a reset pulse to the scan electrodes Y1 to Yn during a reset period to initialize discharge cells corresponding to the whole screen. Further, the scan driver 123 supplies a scan reference voltage Vsc during an address period after supplying the reset pulse, and then a scan pulse falling from the scan reference voltage Vsc to a negative voltage level to the scan electrodes Y1 to Yn, thereby scanning scan electrode lines.

The scan driver 123 supplies a sustain pulse to the scan electrodes Y1 to Yn during a sustain period to generate a sustain discharge in a discharge cell selected during the address period.

The sustain driver 124, under the control of the controller 121, supplies a sustain pulse to the sustain electrodes Z during the sustain period. The scan driver 123 and the sustain driver 124 alternately operates to supply the sustain pulse.

The controller 121 receives a vertical/horizontal synchronization signal, and generates timing control signals CTRX, CTRY and CTRZ required in each driver 122, 123 and 124. The controller 121 supplies the timing control signals CTRX, CTRY and CTRZ to the corresponding drivers 122, 123 and 124 to control each of the drivers 122, 123 and 124. The timing control signal CTRX applied to the data driver 122 includes a sampling clock for sampling data, a latch control signal, and a switch control signal for controlling on/off time of an energy recovery circuit and a driving switch element.

The timing control signal CTRY applied to the scan driver 123 includes a switch control signal for controlling on/off time of an energy recovery circuit and a driving switch element inside the scan driver 123. The timing control signal CTRZ applied to the sustain driver 124 includes a switch control signal for controlling on/off time of an energy recovery circuit and a driving switch element inside the sustain driver 124.

The driving voltage generator 125 generates various driving voltages required in each driver 122, 123 and 124, for example, a sustain voltage Vs, a scan reference voltage Vsc, a data voltage Va, a scan voltage −Vy. These driving voltages may vary in accordance with the composition of the discharge gas or the structure of the discharge cells.

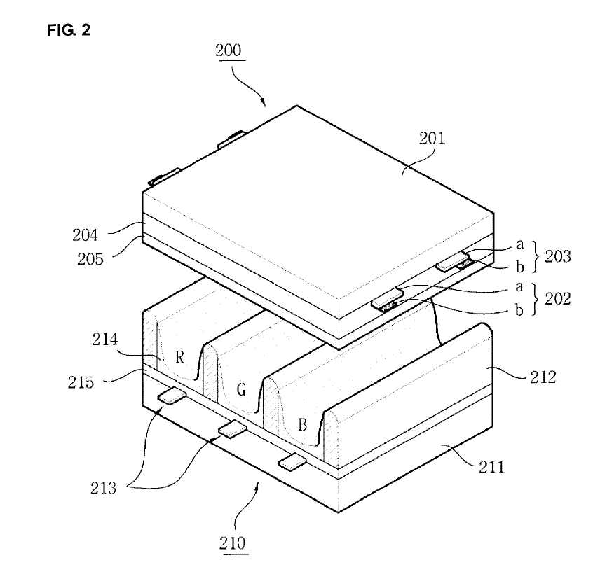

FIG. 2 illustrates the structure of a plasma display panel of the plasma display apparatus.

As illustrated in FIG. 2, the plasma display panel comprises a front panel 200 and a rear panel 210 which are coupled in parallel to oppose to each other at a given distance therebetween. The front panel 200 comprises a front substrate 201 which is a display surface. The rear panel 210 comprises a rear substrate 211 constituting a rear surface. A plurality of scan electrodes 202 and a plurality of sustain electrodes 203 are formed in pairs on the front substrate 201, on which an image is displayed, to form a plurality of maintenance electrode pairs. A plurality of data electrodes 213 are arranged on the rear substrate 211 to intersect with the plurality of maintenance electrode pairs.

The scan electrode 202 and the sustain electrode 203 each comprise transparent electrodes 202a and 203a made of a transparent indium-tin-oxide (ITO) material and bus electrodes 202b and 203b made of a metal material. The scan electrode 202 and the sustain electrode 203 generate a mutual discharge therebetween in one discharge cell and maintain light-emissions of discharge cells. The scan electrode 202 and the sustain electrode 203 each may comprise either the transparent electrodes 202a and 203a or the bus electrodes 202b and 203b. The scan electrode 202 and the sustain electrode 203 are covered with one or more upper dielectric layers 204 to limit a discharge current and to provide insulation between the maintenance electrode pairs. A protective layer 205 with a deposit of MgO is formed on an upper surface of the upper dielectric layer 204 to facilitate discharge conditions.

A plurality of well-type barrier ribs are formed on the rear substrate 211 of the rear panel 210 to form a plurality of discharge spaces, i.e., a plurality of discharge cells. The plurality of well-type barrier ribs comprise a transverse barrier rib (not illustrated) and a longitudinal barrier rib 212. The plurality of data electrodes 213 for performing an address discharge to generate vacuum ultraviolet rays are arranged in parallel to the longitudinal barrier rib 212. The plurality of data electrodes 213 are formed to intersect the scan electrode 202 and the sustain electrode 203. In other words, the scan electrode 202 and the sustain electrode 203 are arranged in parallel to the transverse barrier rib.

An upper surface of the rear substrate 211 is coated with Red (R), green (G) and blue (B) phosphors 214 for emitting visible light for an image display when the address discharge is performed. A lower dielectric layer 215 is formed between the data electrodes 213 and the phosphors 214 to protect the data electrodes 213.

The front panel 200 and the rear panel 210 thus formed are coalesced by a sealing process such that the plasma display panel is completed. The drivers for driving the scan electrode 202, the sustain electrode 203 and the data electrode 213 are adhered to the plasma display panel to complete the plasma display apparatus.

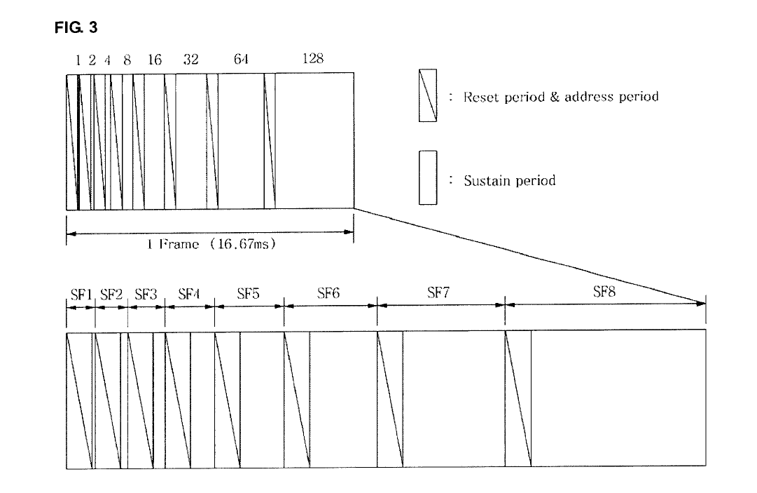

FIG. 3 illustrates an example of a method for achieving gray level of an image displayed on the plasma display panel.

As illustrated in FIG. 3, the plasma display panel is driven by dividing a frame into several subfields. Each of the subfields is subdivided into a reset period for initializing all the cells, an address period for selecting cells to be discharged, and a sustain period for representing gray scale in accordance with the number of discharges.

For example, if an image with 256-level gray scale is to be displayed, a frame period (for example, 16.67 ms) corresponding to 1/60 sec is divided into eight subfields SF1 to SF8. Each of the eight subfields SF1 to SF8 is subdivided into a reset period, an address period and a sustain period. A duration of the reset period in a subfield is equal to a duration of the reset periods in the remaining subfields. A duration of the address period in a subfield is equal to a duration of the address periods in the remaining subfields. However, a duration of the sustain period of each subfield may be different from one another, and the number sustain pulses assigned during the sustain period of each subfield may be different from one another. For example, the sustain period increases in a ratio of 2ⁿ (where, n=0, 1, 2, 3, 4, 5, 6, 7) in each of the subfields such that gray level of an image can be represented.

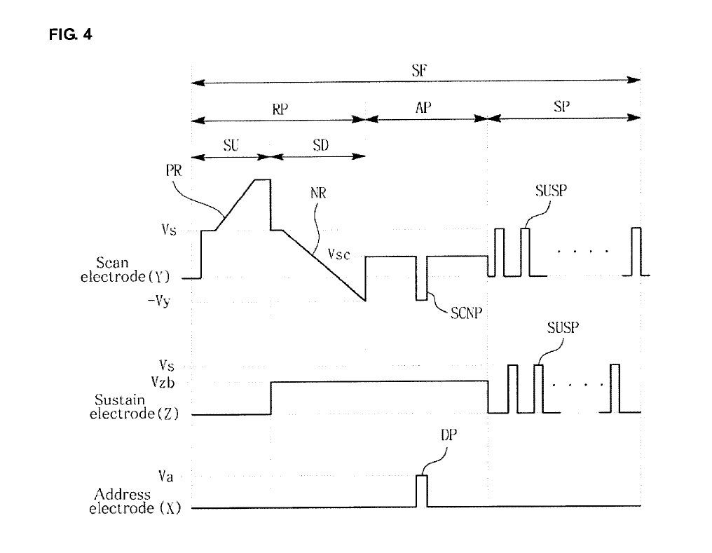

FIG. 4 illustrates an example of a driving waveform of the plasma display panel.

As illustrated in FIG. 4, the plasma display panel is driven by dividing each subfield into a reset period RP for initializing all the cells, an address period AP for selecting cells to be discharged, and a sustain period SP for holding the selected cells in a discharge state.

The reset period RP is further divided into a setup period SU and a set-down period SD. During the setup period SU, a rising pulse PR with a high voltage is simultaneously supplied to all the scan electrodes Y. The rising pulse PR generates a weak discharge (i.e., a setup discharge) within the discharge cells of the whole screen, thereby producing wall charges within the discharge cells. The rising pulse PR may have a sum of a sustain voltage Vs and a scan reference voltage Vsc, for example.

During the set-down period SD, a falling pulse NR is simultaneously supplied to the scan electrodes Y, thereby causing a weak erase discharge within the discharge cells. Accordingly, the wall charges within the discharge cells excessively accumulated by performing the setup discharge remain uniform.

During the address period AP, a scan pulse SCNP with a scan voltage −Vy is sequentially supplied to the scan electrodes Y and, at the same time, a data pulse DP is selectively applied to the data electrodes X. As a voltage difference between the scan pulse SCNP and the data pulse DP is added to a wall voltage produced during the reset period RP, an address discharge occurs within the discharge cells to which the data pulse DP is supplied. Wall charges are produced inside the discharge cells selected by performing the address discharge.

A positive voltage level Vzb is supplied to the sustain electrode Z during the set-down period SD and the address period AP so that an erroneous discharge does not occur between the sustain electrode Z and the scan electrode Y.

During the sustain period SP, a sustain pulse SUSP is alternately supplied to the scan electrode Y and the sustain electrode Z, thereby generating a sustain discharge.

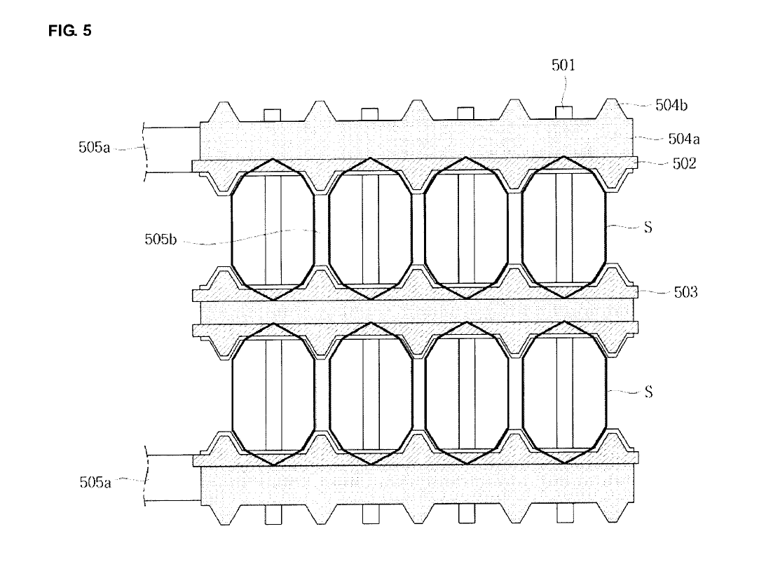

FIG. 5 illustrates another structure of the plasma display panel.

As illustrated in FIG. 5, the well-type barrier ribs are formed between the front substrate and the rear substrate to partition a plurality of discharge cells (S). The well-type barrier ribs partition the plurality of discharge cells (S) such that each of the plurality of discharge cells (S) has a polygon shape having six or more sides or is oval shaped, thereby improving the discharge efficiency. The well-type barrier rib comprises a transverse barrier rib 505a and a longitudinal barrier rib 505b. A scan electrode 502 and a sustain electrode 503 may be formed in parallel to the transverse barrier rib 505a. A data electrode 501 may be formed in parallel to the longitudinal barrier rib 505b.

A black layer is formed at a location corresponding to the barrier rib such that reflectivity of external light lowers, thereby improving contrast. For example, the black layer comprises a first black layer portion 504a formed at a location corresponding to the transverse barrier rib 505a, and a second black layer portion 504b formed at a location corresponding to a portion of the longitudinal barrier rib 505b, thereby minimizing the reflectivity of external light. The first black layer portion 504a and the second black layer portion 504b may be formed to be separated from each other. Further, as illustrated in FIG. 5, the first black layer portion 504a and the second black layer portion 504b may be formed to be connected to each other at an intersection of the transverse barrier rib 505a and the longitudinal barrier rib 505b.

Further, the second black layer portion 504b projects from the first black layer portion 504a at a location corresponding to the longitudinal barrier rib 505b, thereby reducing the reflectivity of external light.

The width of the longitudinal barrier rib 505b decreases until a predetermined distance as the longitudinal barrier rib 505b extends away from the transverse barrier rib 505a, and then remains constant for a predetermined distance such that the discharge space is secured and the discharge efficiency is improved. A width of the second black layer portion 504b may decrease in accordance with the shape of the longitudinal barrier rib 505b. In other words, the second black layer portion 504b projects in the form of a trapezoid, thereby minimizing the reflectivity of external light.

The bus electrodes of the scan electrode 502 and the sustain electrode 503 may be formed to be substantially the same shape as the black layer. In other words, the bus electrode is formed in parallel to the transverse barrier rib 505a at a location corresponding to a portion of the longitudinal barrier rib 505b such that the discharge efficiency increases.

Since the scan electrode 502, the sustain electrode 503 and the black layer are formed not to cover the discharge space, the discharge efficiency is optimized.

The reflectivity of external light can be optimized by controlling an area of the second black layer portion 504b. This will be described in detail below with reference to 6.

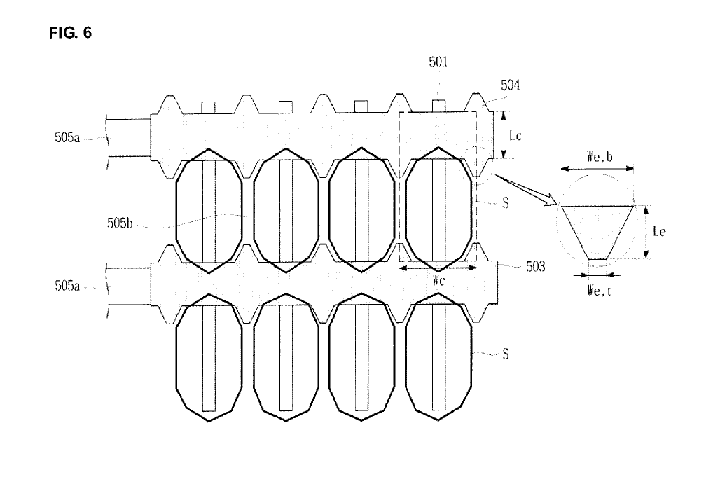

FIG. 6 illustrates the structure of a black layer of the plasma display panel.

As illustrated n FIG. 6, an area of the second black layer portion 504b may range from 20% to 40% of a total area of the black layer. In other words, an area of the black layer per unit cell is obtained by an equation of (Lc×Wc), where Lc indicates a transverse width of the first black layer portion 504a in one discharge cell, and Wc indicates a longitudinal width of the first black layer portion 504a. The area of the second black layer portion 504b ranges from 20% to 40% of the total area of the black layer obtained thus.

For example, the area of the trapezoid shaped second black layer portion 504b is obtained through the lower base (We,t), the upper base (We,t) and the height (Le). As described above, the reflectivity of external light is minimized by controlling the area of the second black layer portion 504b.

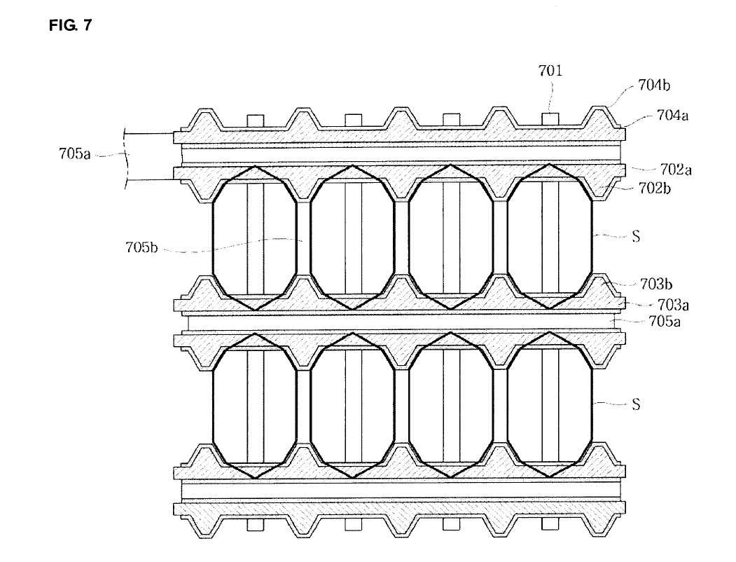

FIG. 7 illustrates still another structure of a plasma display panel according to a third embodiment.

As illustrated in FIG. 7, the well-type barrier ribs are formed between the front substrate and the rear substrate to partition a plurality of discharge cells (S). The well-type barrier ribs partition the plurality of discharge cells (S) such that each of the plurality of discharge cells (S) has a polygon shape having six or more sides or is oval shaped, thereby improving the discharge efficiency. The well-type barrier rib comprises a transverse barrier rib 705a and a longitudinal barrier rib 705b. A scan electrode and a sustain electrode each comprising bus electrodes 702a and 703a made of a metal material may be formed in parallel to the transverse barrier rib 705a. A data electrode 701 may be formed in parallel to the longitudinal barrier rib 705b.

The shape of each of the scan electrode and the sustain electrode is not a straight-line. For example, the bus electrodes 702a and 703a comprise projecting portions 702b and 703b formed at a location corresponding to the transverse barrier rib 705a, thereby increasing the discharge efficiency.

A black layer 704a may be formed to be substantially the same shape as the bus electrodes 702a and 703a, thereby minimizing reflectivity. For example, the black layer 704a may comprise a projecting portion 704b at a location corresponding to the longitudinal barrier rib 705b, thereby improving luminance.

The width of the projecting portions 702b and 703b of the bus electrodes 702a and 703a or the width of the projecting portion 704b of the black layer 704a may decrease as the projecting portions 702b and 703b or the projecting portion 704b extend away from the transverse barrier rib 705a. For example, the shape of each of the projecting portions 702b and 703b of the bus electrodes 702a and 703a or the shape of the projecting portion 704b of the black layer 704a may be a trapezoid, thereby optimizing light-emission efficiency and reflectivity. Accordingly, a high quality of image can be achieved.

As described above, in the plasma display panel, the light-emission efficiency increases and reflectivity of external light decreases such that contrast increases. Further, the plasma display panel improves luminance.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display panel comprising:
a front substrate and a rear substrate;
a well-type barrier rib, formed between the front substrate and the rear substrate, comprising a transverse barrier rib and a longitudinal barrier rib for partitioning a plurality of discharge cells;
a scan electrode and a sustain electrode formed between the front substrate and the rear substrate in parallel to the transverse barrier rib; and
a black layer comprising a first black layer portion formed on the front substrate at a location corresponding to the transverse barrier rib, and a second black layer portion formed on the front substrate at a location corresponding to a portion of the longitudinal barrier rib.

2. The plasma display panel of claim 1, wherein the first black layer portion and the second black layer portion are connected to each other at an intersection of the transverse barrier rib and the longitudinal barrier rib.

3. The plasma display panel of claim 2, wherein the second black layer portion projects from the first black layer portion at a location corresponding to the longitudinal barrier rib.

4. The plasma display panel of claim 1, wherein an area of the second black layer portion ranges from 20% to 40% of a total area of the black layer.

5. The plasma display panel of claim 1, wherein the width of the longitudinal barrier rib decreases until a predetermined distance as the longitudinal barrier rib extends away from the transverse barrier rib, and the width of the longitudinal barrier rib remains constant for a predetermined distance.

6. The plasma display panel of claim 3, wherein the shape of the second black layer portion projection is in the form of a trapezoid.

7. The plasma display panel of claim 1, wherein the well-type barrier rib partitions the plurality of discharge cells such that each of the plurality of discharge cells has a polygon shape having six or more sides.

8. The plasma display panel of claim 1, wherein the well-type barrier rib partitions the plurality of discharge cells such that each of the plurality of discharge cells is oval shaped.

9. A plasma display panel comprising:
a front substrate and a rear substrate;
a well-type barrier rib, formed between the front substrate and the rear substrate, comprising a transverse barrier rib and a longitudinal barrier rib for partitioning a plurality of discharge cells; and
a bus electrode formed on the front substrate or the rear substrate in parallel to the transverse barrier rib, wherein the shape of the bus electrode is not a straight-line.

10. The plasma display panel of claim 9, wherein the bus electrode comprises a projecting portion formed at a location corresponding to the longitudinal barrier rib.

11. The plasma display panel of claim 10, wherein the width of the projecting portion of the bus electrode decreases as the projecting portion extends away from the transverse barrier rib.

12. The plasma display panel of claim 11, wherein the shape of the projecting portion of the bus electrode is a trapezoid.

13. The plasma display panel of claim 9, further comprising a black layer formed to be substantially the same shape as the bus electrode.

14. The plasma display panel of claim 13, wherein the black layer comprises a projecting portion formed at a location corresponding to the longitudinal barrier rib.

15. The plasma display panel of claim 14, wherein the width of the projecting portion of the black layer decreases as the projecting portion extends away from the transverse barrier rib.

16. The plasma display panel of claim 15, wherein the shape of the projecting portion of the black layer is a trapezoid.

17. The plasma display panel of claim 9, wherein the well-type barrier rib partitions the plurality of discharge cells such that each of the plurality of discharge cells has a polygon shape having six or more sides.

18. The plasma display panel of claim 9, wherein the well-type barrier rib partitions the plurality of discharge cells such that each of the plurality of discharge cells is oval shaped.
